(19) United States
(12) Patent Application Publication
(10) Pub. No.: US 2016/0100035 A1
(43) Pub. Date: Apr. 7, 2016

(54) PERSONAL HANDHELD WEB SERVER AND STORAGE DEVICE

(71) Applicant: Eggcyte, Inc., Chandler, AZ (US)

(72) Inventor: Thomas S. Martis, Chandler, AZ (US)

(21) Appl. No.: 14/874,793

(22) Filed: Oct. 5, 2015

Related U.S. Application Data
(60) Provisional application No. 62/060,518, filed on Oct. 6, 2014.

(51) Int. Cl. H04L 29/06; G06F 13/38; G06F 13/40; H04L 29/08

(52) U.S. Cl. CPC H04L 67/42; H04L 67/12; H04L 67/34; H04L 67/04; H04L 67/26; G06F 13/385; G06F 13/4022; H04W 84/12

(57) ABSTRACT

A personal handheld web server that is Wi-Fi connectable to the internet through any wireless modem includes an ergonomic egg-shaped housing enclosing circuitry for a web server; at least Wi-Fi, Bluetooth, and USB communications; and an externally visible video screen for user input, control, music playing, and document viewing. When in communication with the Internet by Wi-Fi, the personal handheld web server has a unique URL by which the personal handheld web server can be accessed by authorized users. The personal handheld web server's Wi-Fi is self-configuring and connects to any router or hotspot. The invention further includes a separate web server (hereinafter “the Server”) that is permanently in communication with the Internet and serves only the personal handheld web servers. All content in messages between the personal handheld web server and the Server is encrypted. Access to the personal handheld web server by persons other than the owner of the personal handheld web server is only by permission of the owner. Files can be shared directly from the personal handheld web server. In addition, local sharing is possible via Bluetooth streaming of audio and via Wi-Fi to share or stream movies, audio, or any file on a LAN. The personal handheld web server can serve as a Wi-Fi hotspot for local streaming.

### RELATED APPLICATIONS

This application claims the benefit of U.S. Provisional patent application No. 62/060,518 filed Oct. 6, 2014 to the same inventor.

### FIELD OF ART

The present invention relates to a Wi-Fi or Cellular connectable personal handheld portable web server. The present invention more particularly relates to such web server with a confidential communication link.

### BACKGROUND OF THE INVENTION

Currently, many web servers that provide cloud services, such as data storage, social networking, cloud sharing, and web site hosting are owned by third parties who mine the user's data for profit, thereby compromising the privacy of the user and the confidentiality of the user's information. For example, document exchange, chats and picture sharing may be mined by third parties, making document security very difficult, and private communications virtually impossible. Additionally, user's have to manage data from a plurality of sources, such as video cameras, still cameras, music sources, and documents of all types.

Accordingly, what is needed is a personal web server with a small enough form factor to be portable and handheld, and that is equipped with software for ensuring privacy of data traffic to and from the portable web server. In addition, the personal web server should provide sufficient memory to store all of a user's web content and should provide means for receiving data from a variety of devices.

### SUMMARY OF THE INVENTION

Briefly described, the invention includes a personal handheld web server that includes an ergonomic egg-shaped housing enclosing circuitry for a web server; Wi-Fi, or optionally, cellular, Bluetooth, and USB communications; and an externally visible video touch screen for user input, control, music playing, photo, video, and document viewing. When in communication with the Internet by Wi-Fi or optionally, cellular, the personal handheld web server has a unique URL by which the personal handheld web server can be accessed by authorized users. The personal handheld web server's Wi-Fi is self-configuring and connects to any router or hotspot. The invention further includes a web server that is permanently located and in communication with the Internet and serves only the personal handheld web servers (hereinafter “the Server”). Communication between the Server and an active Personal handheld web server is by an Internet Protocol version 6 (hereinafter “IPv6”) message wrapped in an Internet Protocol version 4 wrapper (hereinafter “IPv4”). The internet works primarily on IPv4, so the IPv4 wrapper allows a message to or from an Personal handheld web server to travel through any number of conventional routers on its way from or to the Server. Within the personal handheld web server, only IPv6 is used, except for the wrapping step. All content in messages between the personal handheld web server and the Server is encrypted. Access to the personal handheld web server by persons other than the owner of the personal handheld web server is only by permission of the owner, and may be implemented by password protection or other or additional security methods. Files can be shared directly from the personal handheld web server, allowing the user to show photos and files and to stream videos and music. In addition, local sharing is possible via Bluetooth streaming of audio and via Wi-Fi to share or stream movies, audio, or any file. The personal handheld web server can serve as a Wi-Fi hotspot for local streaming.

The user's content remains on the personal handheld web server, is never stored on any machine that is permanently in communication with the Internet, and a permitted viewer can view that content but cannot download the user's content. Permitted viewing can be restricted to a particular subset, as small as one item, of the total content. In addition, un-sharing on the personal handheld web server provides immediate content security, as there is no backup copy, that may go undeleted, on any permanently connected web server. Hacker attacks on Personal handheld web server content are made more difficult as the target is distributed and dynamic (may or may not be on the web at any given moment) instead of centralized and static (the cloud). Finally, third parties cannot track the contents of a personal handheld web server, as third parties have no access, and so cannot monetize the content or content-tracking data.

The personal handheld web server may, when in communication with the Internet, monitor particular data sources for automatic download. For non-limiting example, the user's electronic camera may be monitored and each picture may be downloaded to become content on the personal handheld web server and reduce the need for storage on the camera.

The personal handheld web server can be remotely accessed by the user using a smart phone application or a web browser, and content can be imported to the personal handheld web server via the application. Also, content can be imported locally via USB connection from a phone, camera or other device.

The personal handheld web server can serve as a hub for an Internet of Things (IoT) configuration in, for example, the user's home. A plurality of IoT devices may connect to the personal handheld web server via Wi-Fi or via Bluetooth Low Energy (BLE) connection. The IoT devices can then be controlled from anywhere using the smart phone application or a web browser.

### DESCRIPTION OF THE FIGURES OF THE DRAWINGS

The present invention will hereinafter be described in conjunction with the following drawing figures, wherein like numerals denote like elements, and

FIG. 1A is a front elevation view illustrating an exemplary embodiment of the personal handheld web server, according to a preferred embodiment of the present invention;

FIG. 1B is a front elevation view illustrating an exemplary embodiment of a menu screen of the personal handheld web server of FIG. 1A, according to a preferred embodiment of the present invention;

FIG. 1C is a front elevation view illustrating an exemplary embodiment of the menu screen of FIG. 1B, at a scrolled position, of the personal handheld web server of FIG. 1A, according to a preferred embodiment of the present invention;

FIG. 2 is a diagrammatic view illustrating an exemplary embodiment of the personal handheld web server of FIG. 1 in communication with the World Wide Web, according to a preferred embodiment of the present invention;

FIG. 3 is a front perspective view illustrating an exemplary embodiment of circuitry of the personal handheld web server of FIG. 1, according to a preferred embodiment of the present invention;

FIG. 4 is a perspective view illustrating an exemplary embodiment of the personal handheld web server of FIG. 1 with the front face removed, according to a preferred embodiment of the present invention;

FIG. 5 is a diagrammatic view illustrating an exemplary embodiment of the functions of the personal handheld web server of FIG. 1, according to a preferred embodiment of the present invention;

FIG. 6 is a diagrammatic view illustrating an exemplary embodiment of the personal handheld web servers of FIG. 1 in communication with the World Wide Web in a private chat configuration, according to a preferred embodiment of the present invention;

FIG. 7 is a diagrammatic view illustrating an exemplary embodiment of the personal handheld web server of FIG. 1 in wireless communication with external devices over the Internet, according to a preferred embodiment of the present invention;

FIG. 8 is a diagrammatic view illustrating an exemplary embodiment of the personal handheld web server of FIG. 1 in wireless communication locally to external devices, according to a preferred embodiment of the present invention;

FIG. 9 is a diagrammatic view illustrating an exemplary embodiment of the personal handheld web server of FIG. 1 in USB cable communication to a photographic device, according to a preferred embodiment of the present invention;

FIG. 10 is a diagrammatic view illustrating an exemplary embodiment of the personal handheld web server of FIG. 1 communicating through a firewall using a tunnel broker, according to a preferred embodiment of the present invention;

FIG. 11 is a diagrammatic view illustrating an exemplary embodiment of the personal handheld web server of FIG. 1 communicating through a firewall to a wide area network, according to a preferred embodiment of the present invention; and

FIG. 12 is a diagrammatic view illustrating an exemplary embodiment of a software architecture of the personal handheld web server of FIG. 1, according to a preferred embodiment of the present invention.

### DETAILED DESCRIPTION OF THE INVENTION

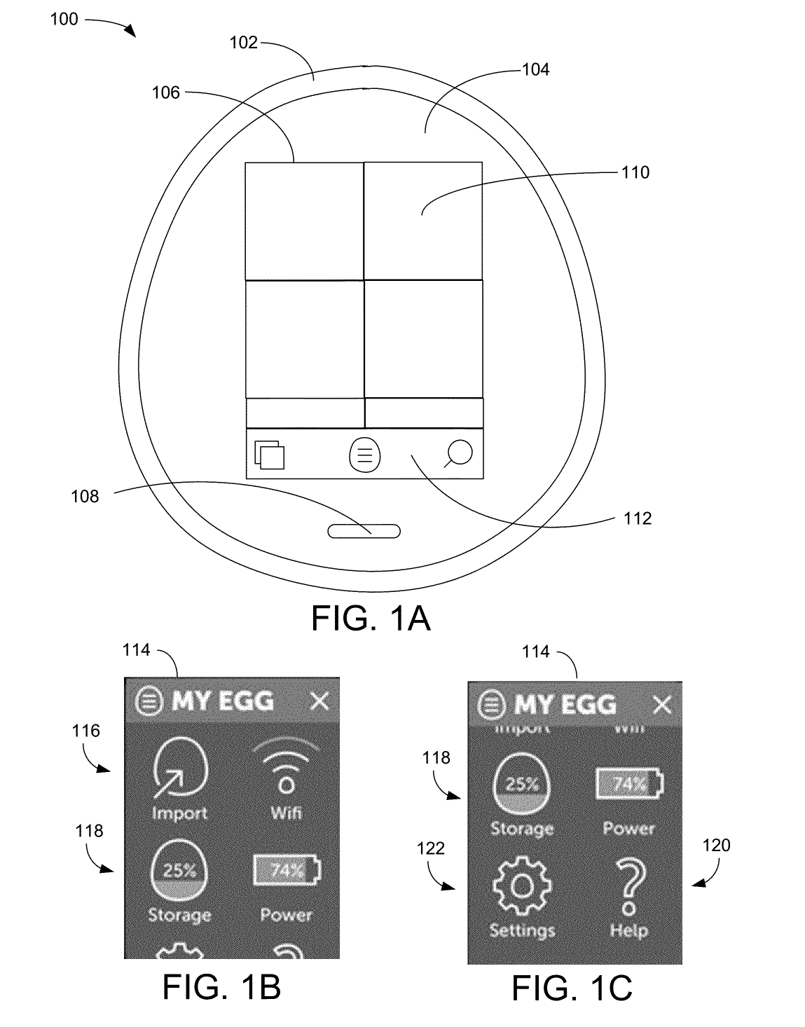

FIG. 1A is a front elevation view illustrating an exemplary embodiment of the personal handheld web server 100, according to a preferred embodiment of the present invention. The personal handheld web server 100 includes a housing 102, preferably shaped like half of an egg, a front support panel 104 covering the internal components and supporting a touch screen 106 and a home button 108. Housing 102 is preferably made of injection molded plastic. In other embodiments, similarly functional housings 102 may be used. The touch screen 106 may be divided into content displays 110 (one of six labeled) and an iconic control bar 112. Touch screen 106 is responsive to touch for scrolling and selection. Touch screen 106 is preferably a 2.4″ multi-touch capacitive touch thin-film transistor display with a resolution of 240×320 pixels and 262K colors. In other embodiments, similarly functional touch screens 106 may be used.

FIG. 1B is a front elevation view illustrating an exemplary embodiment of a menu screen 114 of the personal handheld web server 100 of FIG. 1A, according to a preferred embodiment of the present invention. Menu screen 114, which may be displayed on touch screen 106, shows command icons 116 and status icons 118. The command icon 116 portions of the touch screen are responsive to touch to initiate command sequences and the status icon 118 portions of touch screen 106 are responsive to touch to provide more detailed information regarding status. The content displays 110 and menu display 114 are merely exemplary and do not limit the invention.

FIG. 1C is a front elevation view illustrating an exemplary embodiment of the menu screen 114 of FIG. 1B, at a scrolled position, of the personal handheld web server 100 of FIG. 1A, according to a preferred embodiment of the present invention. Menu screen 114 is shown in a scrolled position, showing an administrative icon 122 and a help icon 120.

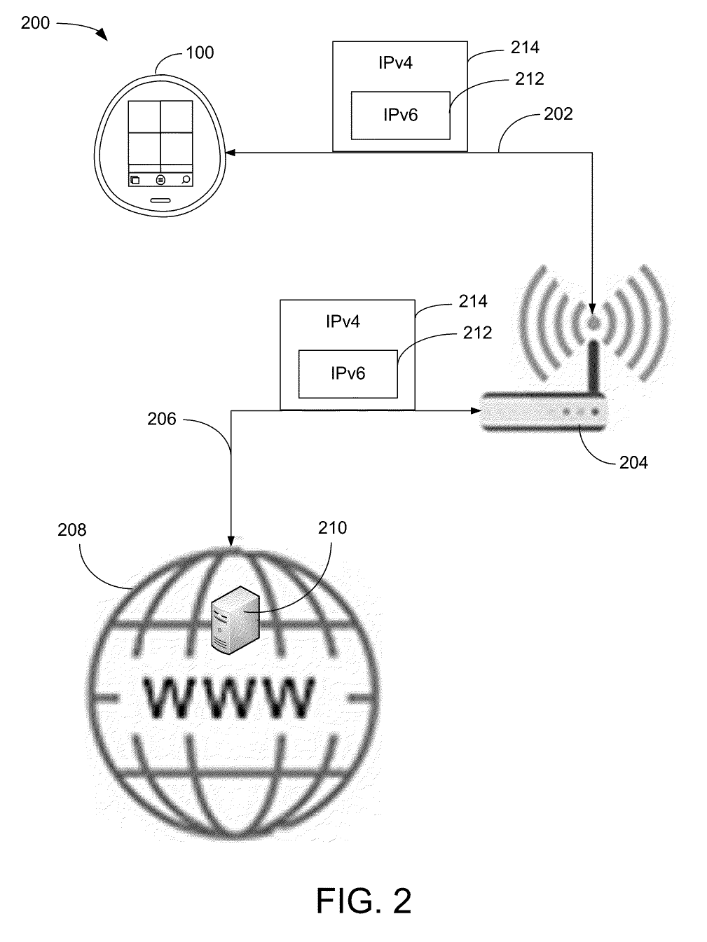

FIG. 2 is a diagrammatic view illustrating an exemplary embodiment of the personal handheld web server system 200, including the personal handheld web server 100 of FIG. 1 in communication with the Internet 208, according to a preferred embodiment of the present invention. Personal handheld web server 100 is a node on the Internet 208 whenever it is wirelessly connected 202 to an Internet-connected 206 router 204 and can host websites with unique URLs that can be accessed over the Internet 208 like any other web site by a person having the permission of the owner of the particular personal handheld web server 100.

Personal handheld web server 100 is Wi-Fi enabled for Wi-Fi a/b/g/n/ac/ad and automatically connects to a wireless router 204 unless the owner unselects that feature. Alternatively, the personal handheld web server may be connected to the Internet through a Cellular connection. Wi-Fi enables personal handheld web server 100 to communicate using internet protocol version 4 (hereinafter “IPv4”) and internet protocol version 6 (hereinafter “IPv6”), as well as having the capability to wrap an IPv6 message 212 in an IPv4 wrapper 214. In connecting to the Internet, personal handheld web server 100 sends an IPv6 message 212 in a IPv4 wrapper 214 to wireless router 204 which forwards the message to the Internet 208 along cable 206. In additional embodiments, there may be a wireless connection between wireless router 204. Part of the Internet 208 is a particular server 210 that is dedicated to handling messages 212 and 214 from many personal handheld web servers 100. Server 210 may be a single computer or, in additional embodiments, a server farm. Server 210 is programmed to forward the IPv4-wrapped IPv6 messages to IPv4 destinations. For IPv6 destinations, server 210 unwraps the IPv6 message and sends it. Messages 212 and 214 going to the personal handheld web servers 100 also go through server 210. The messages 212 and 214 carry content from the personal handheld web servers 100. Messages 212 and 214 are not stored on or by server 210 beyond momentary RAM storage necessary for processing. Personal handheld web servers 100 encrypt all outgoing messages 212 and 214 and particular Server 210 encrypts all messages 212 and 214 going to the personal handheld web servers 100.

In an additional embodiment, personal handheld web server 100 is also capable of communicating over cellular telephone frequencies to connect to the Internet 208, in the manner of a cellular smart phone.

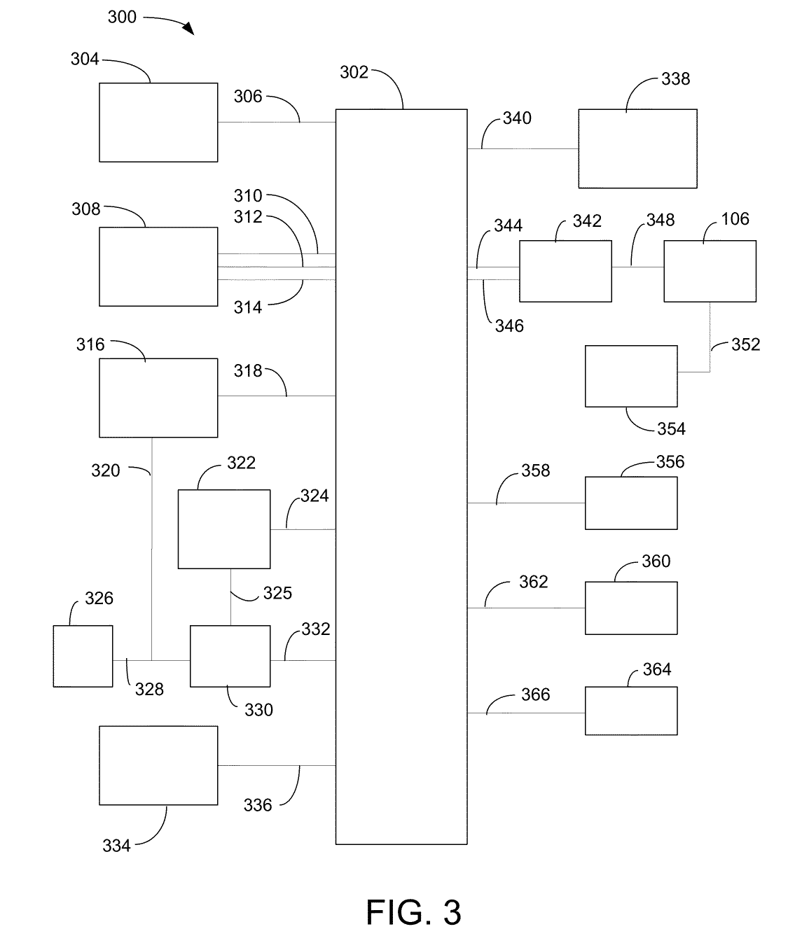

FIG. 3 is a front perspective view illustrating an exemplary embodiment of circuitry 300 of the personal handheld web server 100 of FIG. 1, according to a preferred embodiment of the present invention. A central processing unit (CPU) is provided in a system-on-chip (SoC) 302 configuration. Preferably, the CPU is an Intel® Atom™ Processor running a Linux operating system. In various other embodiments, other processors and other operating systems of adequate functionality may be used. Random-access memory (RAM) 304 is in communication with CPU 302 via a 32-bit data line 306. Preferably, the RAM is double data rate type three synchronous low voltage dynamic random-access memory (DDR3L DRAM). In additional embodiments, other RAM with low power requirements may be used. Radio receiver 308 receives wireless local area network (WLAN), marketed as Wi-Fi; Bluetooth (BT); and frequency modulated radio (FM) signals and communicates with a universal asynchronous receiver/transmitter (UART) within SoC 302 on line 310, communicates with the SoC 302 on data line 312, and communicates with a secure digital input output (SDIO) within the SoC 302 on line 314. Power management integrated circuit (PMIC) 316 is in communication with a system block within SoC 302 over data line 318. PMIC 316 receives power from micro USB port 326 over line 320 when a power source is connected to micro USB port 326. Data from micro USB port 326 is communicated to USB switch 330 over line 328. USB switch 330 communicates USB on-the-go data to USB2.0 transceiver chip 322 via line 325. USB 2.0 transceiver chip 322 communicates with a USB 2.0 transceiver macrocell low pin-count Interface (UPLI) within the SoC 302 via line 324. USB switch 330 also communicates USB 2.0 data to USB 2.0 Port0 on the SOC 302 on line 332. USB 2.0 socket 334 communicates USB 2.0 data to USB 2.0 Port1 in the Soc 302 via line 336.

High-definition multimedia interface (HDMI) output socket 338 receives HDMI data over line 340 and enables communication of video and audio data to end user devices. A mobile industry processor interface (MIPI) within SoC 302 communicates to MIPI-RGB converter 342 over MIPI line 344. Additional data is communicated from the SoC to MIPI-RGB converter 342 over line 346. MIPI-RGB converter 342 communicates RGB video data to RGB touch screen panel 106 over line 348. Microcontroller 354 communicates with RGB touch screen 106 over SDIO line 352 to provide control of touch screen 106 operations. Serial peripheral interface (SPI) flash memory 356 communicates with a SPI interface within SoC 302 over line 358. A secure digital (SD) card socket 360 is in communication with SoC 302 over line 362. At least sixty-four gigabytes, and preferably 256 gigabytes, of flash memory in an embedded memory management controller chip 364 communicate with SoC via line 366.

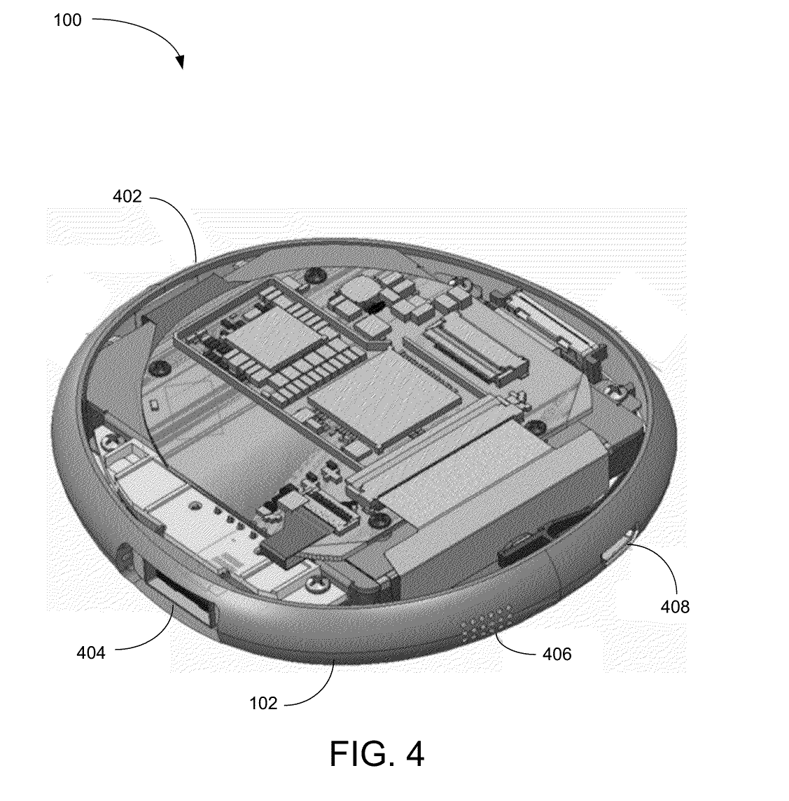

FIG. 4 is a perspective view illustrating an exemplary embodiment of the personal handheld web server 100 of FIG. 1 with the front face removed, according to a preferred embodiment of the present invention. Housing 102 supports an ON/OFF switch 402, a standard USB 2.0 port 404, a speaker grill, 406, and a micro USB port 408. Housing 102 also supports the electronic components described in regard to FIG. 3. In addition, housing 102 supports an accelerometer, a compass, and an ambient light sensor. Out of view in this figure are indicator lights on the periphery of the housing and a plurality of communications antennas also supported by housing 102. Additionally, a rechargeable battery pack, preferably a Lithium-ion battery pack, delivering 4.35 volts at 1800 mAh, is supported within the housing 102. Finally, a vibration motor for haptic communication is supported within housing 102.

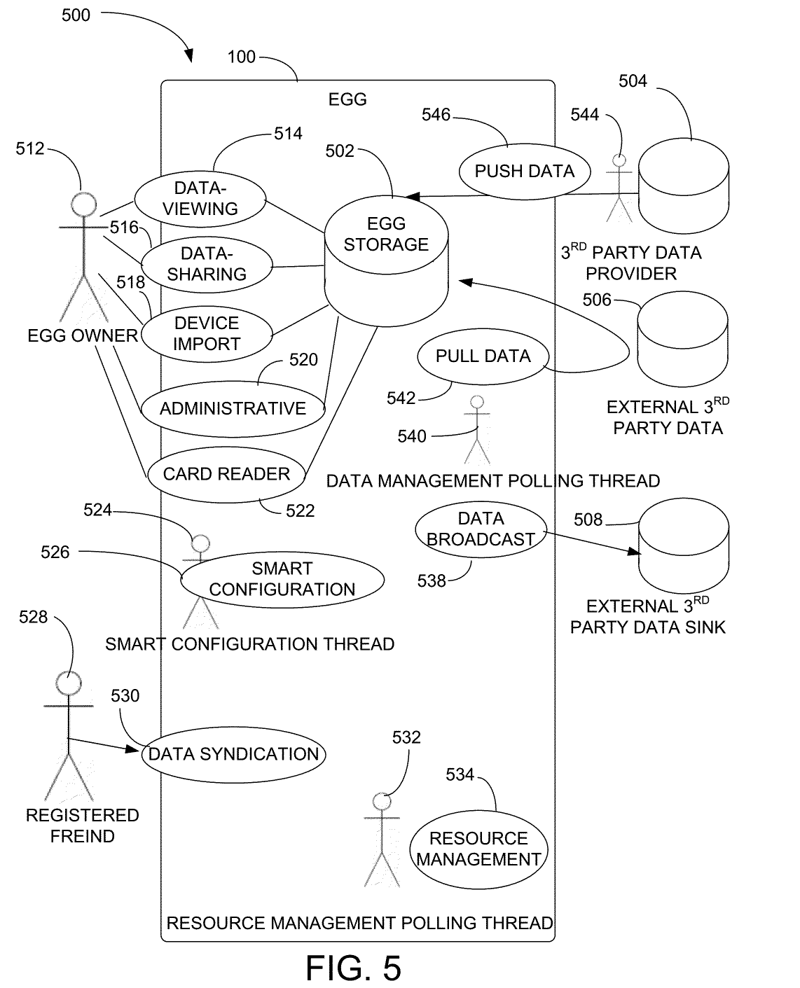

FIG. 5 is a diagrammatic view illustrating an exemplary embodiment of the functions 500 of the personal handheld web server 100 of FIG. 1, according to a preferred embodiment of the present invention. Personal handheld web server 100 (sometimes “Egg” in the drawings) is personal property of personal handheld web server owner 512 who has primary access to stored content database 502 within the personal handheld web server 100. Owner 512 can view 514 stored content 502, share 516 stored content, and import 518 additional content into the personal handheld web server's 100 database via connection of one or more of the personal handheld web server owner's 512 devices to the personal handheld web server 100 for the purpose of importing some set of assets from those devices. The import connection can be either via physical USB cable or a wireless connection. The personal handheld web server owner 512 may also perform administrative actions 520, such as, without limitation, updating software or assigning permissions to authorized viewers of stored content 502. The personal handheld web server owner 512 can also add or copy 522 stored content via an SD card reader.

A sort-by-time function of the data-viewing function 514 involves manipulating the tile-based timeline on the user interface to view some subset of data on the personal handheld web server 100. For example, in a 2×2 viewing mode, there are four separate icons/thumbnail images representing four different assets arranged in a simple grid. Each viewing mode represents a different representation of time. Each tile 110 on the screen 106 represents an asset or a collection of assets. More tiles 110 on the screen 106 represent a greater period of time (e.g. year view). Fewer tiles 110 on the screen 106 represent a smaller period of time (e.g. day view).

The compress timeline function of the data-viewing function 514 is the action taken to view a larger period of time on the timeline. Compression of time will have the effect of “zooming out” or “drilling up”. Compressing the timeline involves a pinch-in action using two fingers on the touch screen 106 to show more tiles/assets on the display 106. As more assets are shown on the display 106, they will be represented with smaller icons so that more time can fit on the display 106.

The contract timeline function of the data-viewing function 514 is the action taken to view a smaller period of time on the timeline. Contraction of time will have the effect of “zooming in” or “drilling down”. Timeline contraction involves a pinch-out action using two fingers on the touch screen 106 to show fewer tiles/assets on the display 106. As fewer assets are shown on the display 106, they will be represented with larger icons.

For the sort by sender function of the data-viewing function 514, each viewing mode contains a frame around the assets on the display. If the personal handheld web server owner 512 clicks on the asset, the user interface allows switching by the various attributes of the asset such as “sort-by-creator” mode in which only the assets created by a particular device or user will be displayed.

The Fetch Me That function of the data-viewing function 514 allows the personal handheld web server owner 512 to be able to search the local asset database 502 on the personal handheld web server 100 to locate all assets based on the meta-data information that is collected for each asset during import. This includes asset type (what), asset import/creation time (when), asset creator (who), and/or asset geo/location (when). However, some of the meta-data may not apply to all assets. For example asset and asset geolocation might be available for photos but might not be available for Email. The asset database 502 can also be searched by additional metadata that is added by the user or created through automated algorithms such as face/scenario recognition.

The narrowcast function of the data-sharing function 516 enables the personal handheld web server owner 512 to share (narrowcast) an asset or a collection of assets and make it available for a target group of recipients to view on a remote device on the Local Area Network (LAN) or over the wide area network (WAN), where the WAN may be the Internet 208. Every asset stored locally on the personal handheld web server 100 has a “Share” button attached to it in the user interface. Selecting this button and selecting a target set of recipients will generate an email with a set of URL links pointing to the assets and send it to the target group. When the target recipient receives the email and clicks on the URL link, the target recipient will be taken to a registration page that the personal handheld web server 100 will serve up. After registering with the personal handheld web server 100, the personal handheld web server 100 will serve up the content via the web server for viewing. Note that the URL can be a sub-domain such as, for non-limiting example, johndoe.eggcyte.com or a unique domain such as www.johndoe.com.

The device-driven asset import functions 518 all involve the connection of one or more of the personal handheld web server owner's 512 devices into the personal handheld web server 100 for the purpose of importing some set assets from that device into the personal handheld web server's database 502. This connection can be either be via physical USB cable 904 (see FIG. 9) or a wireless connection (Wi-Fi, Bluetooth, or near field communication (NFC)).

The USB-cable based asset import function of the data-sharing function 518 involves the connection of one or more of the personal handheld web server owner's 512 devices 902 (see FIG. 9), which may be any device that supports a USB connection, to the personal handheld web server 100 and the importing of assets from that device 902 (see FIG. 9) into the personal handheld web server's database 502. When the device is connected to the personal handheld web server 100 via USB 904 (see FIG. 9), the personal handheld web server owner 512 is prompted on the personal handheld web server's display 114 to confirm the transfer (import) of one or many of the assets (for non-limiting example, image files) from that device 902 (see FIG. 9) into the personal handheld web server 100. Once the personal handheld web server owner 512 confirms the transaction, one or many of the assets will be digitally transferred into local storage 502 on the personal handheld web server 100. The USB-cable based asset import function will support iOS devices, Android devices, and USB mass storage devices (e.g. digital cameras and USB memory sticks) and any other device that utilizes the Media Transfer Protocol (MTP) or the Picture Transfer Protocol (PTP).

The Wi-Fi based asset import function of the data-sharing function 518 involves transferring data assets between the owner's devices (such as iphones 802 (see FIG. 8), cameras 902 (see FIG. 9), etc.) using an application installed on the device that knows how to discover the personal handheld web server 100 and automatically connect to it through the following steps: Discover (who is out there) using a customized version of the Avahi framework, Connect, Communicate, Enumerate (tell me about you and your friends, functions, and command—topology) and Authenticate (accept the request to connect).

The Bluetooth based asset import function of the data-sharing function 518 involves substantially the same steps as for Wi-Fi based asset import function of the data-sharing function 518.

The NFC based asset import function of the data-sharing function 518 involves substantially the same steps as for Wi-Fi based asset import function of the data-sharing function 518.

The smart configuration function 526 is responsive to the smart configuration thread 524 to configure the personal handheld web server 100 to the available and actual connections, both wired and wireless. The smart configuration thread 524 periodically polls configuration status and generates data upon which the smart configuration function 526.

Data syndication functions involves a mechanism similar to subscribing to an RSS feed. A registered friend/device 528 to the personal handheld web server 100 can subscribe to the personal handheld web server owner's 512 information/data feed. When the personal handheld web server owner 512 has something that he would like published, the content would automatically be pushed 530 to all registered subscribers 528. Another function is the inverse case where the personal handheld web server owner 512 subscribes to an external 3rd party feed and the 3rd party pushes 530 the information to the personal handheld web server 100.

The push data function 546 supports the import of asset data from external 3rd party 544 sources 504. This category of functions 546 involve the transfer of data into the personal handheld web server 100 whereby the external entity 544 initiates or pushes the data into the personal handheld web server 100. The personal handheld web server 100 provides a public web-based application programming interface (API) that allows 3rd parties 544 to make calls to send data 504 into the personal handheld web server 100. An XML-based description template is provided to 3rd parties 544 to define their data content, and the layout/format/presentation of the data content. Third parties 544 will have to register with the personal handheld web server 100 to receive a time-based token which allows them to authenticate with the personal handheld web server 100 and gain authorization to use this data importing API.

A 3rd party asset import function allows external 3rd parties 544 to initiate the transfer of asset data 504 into the personal handheld web server 100 asynchronously on-demand. Non-limiting examples of the 3rd party asset import function can include sensitive real-time data (e.g. stock ticker) that is important for the personal handheld web server owner 512 to see immediately or in a time-sensitive scenario. Advertisements are another exemplary application of the 3rd party asset import function.

The browser plug-in function of the push-data function 546 involves the deployment of a browser plug-in that is downloadable and installable from the personal handheld web server 100 when a client device is connected to the personal handheld web server 100 or from a website server that is publicly accessible. The purpose of the plugin is to track the history of the client device user's 544 browsing session so that it can be recorded in the personal handheld web server's database 502. Additionally, there is a capability whereby the user 544 can decide to save off the current page being viewed on the client device for offline viewing later, on the client device or even on the personal handheld web server's display 114. Only the current page along with any images on that page will be saved off. The HTML page will be formatted appropriately if the user 544 decides to view the page on the personal handheld web server's 100 smaller display 114.

The pull-data category of functions 542 involve the periodic polling and fetching of mostly online services data 506 and storing it to the personal handheld web server 100 local storage 502. The pull-data category of functions 542 includes online social networking services like Facebook and Twitter and POP/IMAP based Email services like Gmail and Yahoo. A systems settings file stores default polling periods and services to be polled. Each service to be polled is described by an XML-based description configuration file that specifies what information is to be retrieved, how the data is presented/formatted/laid out for surfacing, the period for polling, and the destination URL used to fetch the data. The use of an XML-based description configuration file allows just about any 3rd party data 506 to be polled and retrieved.

The data broadcast category of functions 538 involve the broadcast/export of personal Personal handheld web server owner 512 information to some external 3^{rd} party data sink 508 for the purpose of alert notifications and/or commerce. Emergency broadcast notification functions of the data broadcast category of functions 538 involve the definition of an emergency broadcast message and a message protocol that allows external 3rd parties to consume 508 the information for alert notification purposes. Applications for this could involve medical or other emergency-related alert scenarios. Advertisement-based broadcast functions of the data broadcast category of functions 538 involve the definition of a public profile schema that allows the personal handheld web server owner's 512 demographic information and/or buying preferences to be exported to external 3rd party entities 508 that are interested in consumption of this data for purposes of commerce. A messaging protocol that matches businesses with consumers is provided as a part of this function.

The resource management functions 534 are responsive to data from the resource management polling thread 532 to control resources internal to the personal handheld web server 100. The personal handheld web server application software is instrumented with various hooks to measure performance, timing, and usage metrics. In addition, error and debug hooks are inserted to assist developers for in-field debugging work. Each resource management functions 534 area will be covered in a separate sub-section.

Battery performance monitoring functions of the resource management functions 534 closely monitors one of the most critical system resources. This monitoring allows better tuning of the system software (e.g. polling periods, reduction of unnecessary system threads, etc. . . . ) for optimum performance and user experience satisfaction.

Timing metrics monitoring functions of the resource management functions 534 monitors critical system features/functions to benchmark performance characteristics. Over time, as monitored data is accumulated, performance levels can be characterized more accurately and timing metrics monitoring will allow modification of system settings that will provide improved system performance.

Webserver response monitoring functions of the resource management functions 534 monitors connections to the Internet or LAN. The personal handheld web server 100 includes a micro-server running NGINX web server on limited resources. The number of simultaneous connections is monitored closely to characterize the latency of serving up content given these connections.

Database queries monitoring of the resource management functions 534 monitors queries to database 502. Running database queries can be a bottleneck in the system and as such, every query response time is recorded and logged to provide a better characterization on how to improve performance as the database 502 size grows.

Feature usage and coverage monitoring functions of the resource management functions 534 collect data used for feature assessment. In order to gauge which features on the personal handheld web server 100 are useful to users and which features are not as useful, hooks are inserted to capture usage metrics on each of the functions in the personal handheld web server 100.

Error logging and debug logging functions of the resource management functions 534 monitor and collect data for use in field debugging as well as software updates and improvements. To assist the software development team in root-causing issues in the field, hooks are inserted into the production code that will log error and debug conditions so that the logs can be captured and retrieved for field debugging and software improvements.

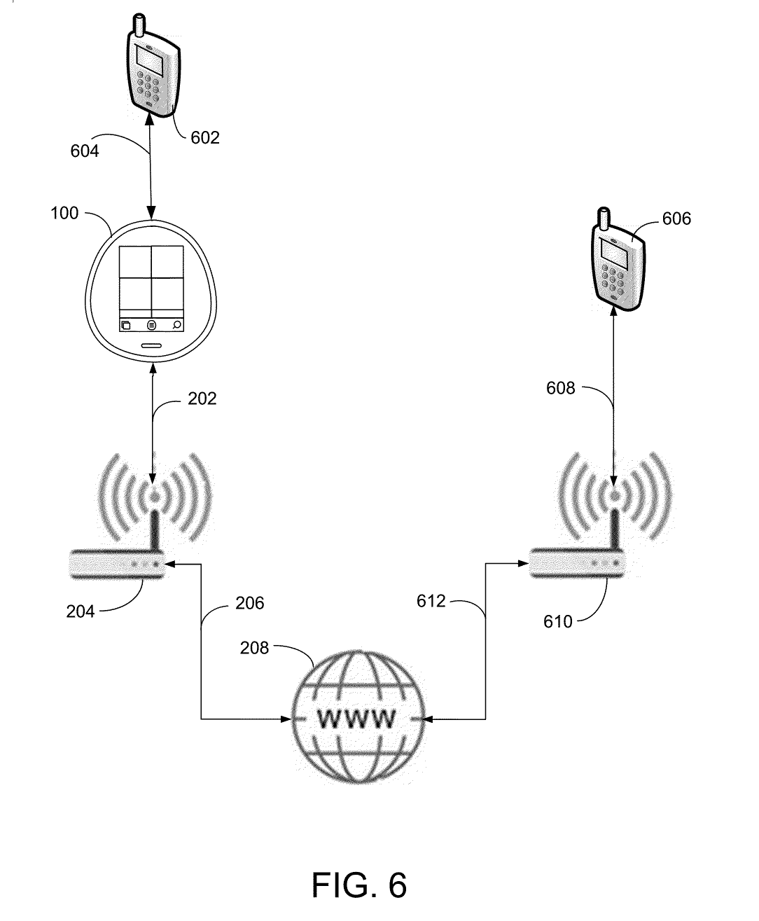

FIG. 6 is a diagrammatic view illustrating an exemplary embodiment of the personal handheld web servers of FIG. 1 in communication with the World Wide Web in a private chat configuration, according to a preferred embodiment of the present invention. Beginning with a smart phone 602, owned by the personal handheld web server owner, that is Wi-Fi and Internet browser enabled, a wireless link 604 is established with personal handheld web server 100. Chat information is created using the smart phone 602 and transmitted to the personal handheld web server 100. The chat information is not stored on the smart phone 602 beyond RAM storage for processing: no copy is placed in or retained in storage on the smart phone 602. Personal handheld web server 100 has a connection to chat partner's smart phone 606 via wireless link 202, wireless router 204, internet cable 206, through routers on the Internet 208 to internet cable 612 to wireless router 610, and over wireless link 608. In another embodiment, 608, 610 and 612 are replaced by a single Cellular connection that smart phone 606 has with the Internet 208. Chat information received in chat partner's smart phone is not stored on the smart phone 606 beyond RAM storage for processing: no copy is placed in or retained in storage on the smart phone 606. Chat message content is not normally stored on the wireless routers 204 and 610, nor on the various routers within the Internet 208. Particular server 210 cooperates to ensures that all messages to and from Personal handheld web server 100 are encrypted, so in the extraordinary case that someone did monitor chat message content, the contents would be incomprehensible. Accordingly, the chat is entirely private. When the chat session is deleted, no copy of its contents remains.

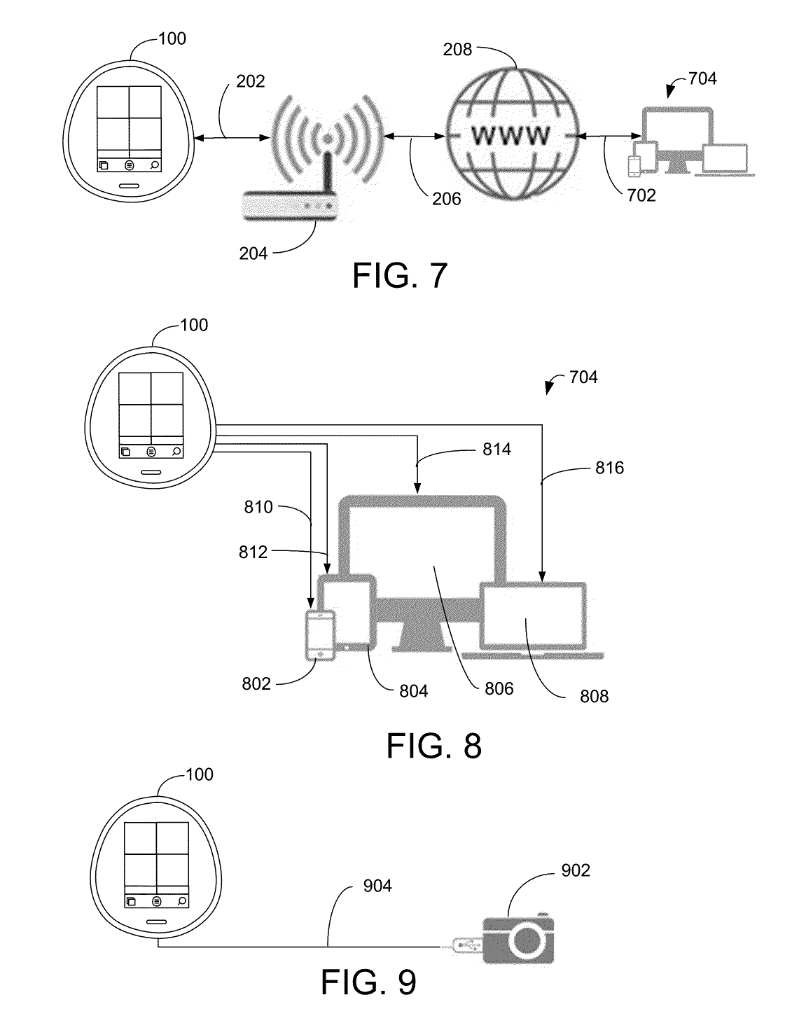

FIG. 7 is a diagrammatic view illustrating an exemplary embodiment of the personal handheld web server 100 of FIG. 1 in wireless communication with external devices 704 over the Internet 208, according to a preferred embodiment of the present invention. The personal handheld web server 100 can wirelessly 702 stream data, including video and audio, over the Internet 208 to Internet-enabled devices such as smart phones and tablets running an appropriate application, or a web browser on a laptop or desktop computer. Connectivity from the personal handheld web server 100 to the Internet 208 is as previously described in regard to FIG. 2.

FIG. 8 is a diagrammatic view illustrating an exemplary embodiment of the personal handheld web server 100 of FIG. 1 in wireless communication locally to external devices 704, according to a preferred embodiment of the present invention. When not connected to the Internet 208, Personal handheld web server 100 can perform as a wireless access point for transferring data to and from Wi-Fi enabled, Internet browser enabled devices 704. Personal handheld web server 100 can provide a wireless link 810 to smart phone 802, another link 812 to tablet computer 804, yet another link 814 to desktop computer 806, and still yet another link 816 to laptop computer 808. The personal handheld web server 100 is not limited to four links. The data transferred may be streaming video, music, other audio, or data files, including documents.

FIG. 9 is a diagrammatic view illustrating an exemplary embodiment of the personal handheld web server 100 of FIG. 1 in USB cable 904 communication to a photographic device 902, according to a preferred embodiment of the present invention. In this configuration, a photograph taken with photographic device 902, such a camera, is automatically pulled into memory 502 in the personal handheld web server 100. The photograph is stored on the photographic device. However, the personal handheld web server 100 may be configured to either, move (i.e. copy from and then delete from the source photographic device 902) or copy the photograph(s) to the storage 502 on the personal handheld web server 100. The same is true for any USB device photographic device 902, except temporarily in RAM for processing. The configuration of FIG. 9 reduces long term storage requirements on the photographic device 902. The configuration of FIG. 9 is not limited to photographic devices 902. For non-limiting example, any transducer capable of supplying data to a USB port could be connected to the personal handheld web server 100, and the data could be automatically pulled into memory 502 of personal handheld web server 100 as it is produced, and further displayed on a remote Internet-connected device 704 as shown in FIG. 7.

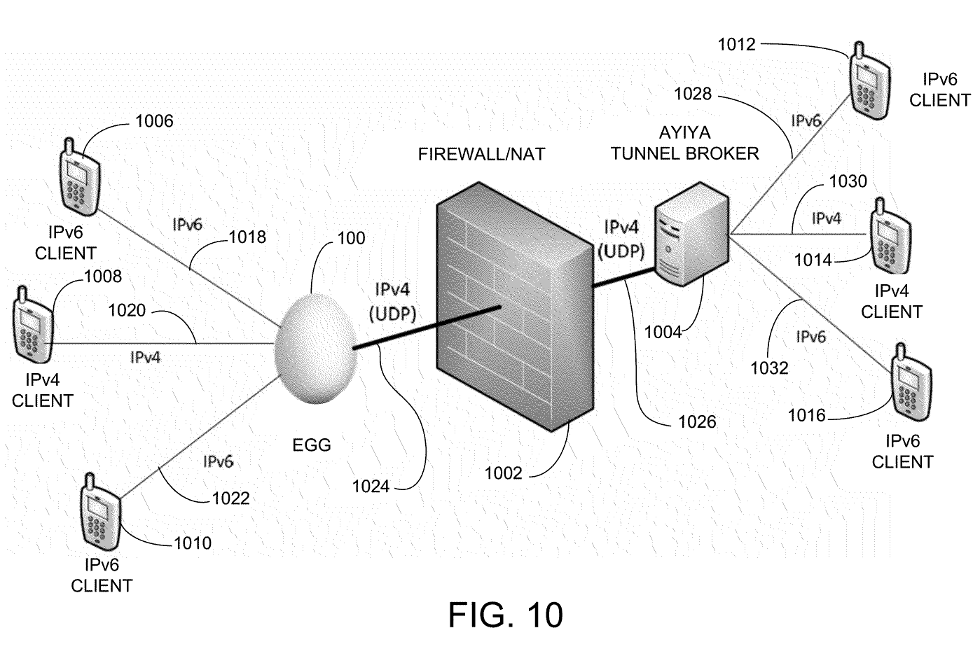

FIG. 10 is a diagrammatic view illustrating an exemplary embodiment of the personal handheld web server 100 of FIG. 1 communicating through a firewall 1002 using a tunnel broker 1004, according to a preferred embodiment of the present invention. FIG. 10 illustrates a particular connection scheme for narrowcasting. At the network layer, it's important to distinguish how the connection is made in the LAN case and the WAN case as the mechanisms are very different. There are two approaches (IPv4 and IPv6) for narrowcasting (sharing) assets to a remote device over a WAN and two approaches (IPv4 and IPv6) for narrowcasting assets to a device on a LAN.

The primary difference between the WAN and LAN approaches is the involvement of an IPv6/IPv4 tunnel broker 1004 running a customized version of the tunneling protocol detailed under IETF-RFC4891 between the personal handheld web server 100 and the client device in the WAN case. The primary reason there is a need for a tunnel broker 1004 is to overcome the existence of a network address translation (NAT) device 1002 that typically sits between an IP device 1006, 1008, 1010 in a home/office environment and an IP device 1012, 1014 and 1016 outside of that firewalled 1002 environment. A secondary reason a tunnel broker 1004 is needed is to tunnel IPv6 packets from an IPv6-enabled device 1012 and 1016 on the outside to the personal handheld web server 100 running over IPv4 to the tunnel broker 1004. This allows for a natural transition from IPv4 to IPv6 as the new standard is slowly adopted towards ubiquity. For an Personal handheld web server 100 connected to client devices in a LAN environment, no such tunnel broker 1004 is necessary. Personal handheld web server 100 can communicate to IPv6 clients directly over IPv6 and directly to IPv4 clients that do not support IPv6 over IPv4.

In the narrowcast Personal handheld web server 100 content sharing to an IPv4 device over WAN scenario, the personal handheld web server 100 will typically sit behind a NAT/firewall 1002 in a home or office environment. If the personal handheld web server owner 512 has sent out a sharing invitation to a remote client device 1014 over the WAN 1026 and 1030 to an IPv4-based (not IPv6 capable) device 1014, the recipient connects to the personal handheld web server's 100 web server using IPv4 user datagram protocol (UDP) via a company-owned tunnel broker 1004 running the afore-mentioned tunneling protocol. This allows the client device 1014 to be able to get past the NAT/firewall 1002 and connect to the personal handheld web server's 100 web server.

In the narrowcast Personal handheld web server 100 content sharing to an IPv6 1012 and 1016 device over WAN scenario, the personal handheld web server 100 will again be sitting behind a NAT/firewall 1002 in a home or office environment. If the personal handheld web server owner 512 has sent out a sharing invitation to a remote client device over the WAN 1024, 1002, 1026, 1004,1028 and 1032 to an IPv6-based device 1012 or 1016, the recipient connects to the personal handheld web server using IPv6 (UDP) via a company-owned tunnel broker 1004 running the afore-mentioned tunneling protocol. This allows the client device 1012 or 1016 to be able to get past the NAT/firewall 1002 and connect to the personal handheld web server 100. The communication between the personal handheld web server 100 and the tunnel broker will be via IPv4 (UDP) wrapper over the IPv6 message.

In the narrowcast Personal handheld web server 100 content sharing to an IPv4 device over LAN 1024, 1018, 1020 and 1022 scenario, the personal handheld web server 100 will be operating with a single-mode antenna (i.e. it will not itself be connected to another wireless access point/router to get to WAN/Internet). In this scenario, client devices 1006, 1008 and 1010 can connect to the personal handheld web server 100 directly. If the client device 1008 is only IPv4 capable, the personal handheld web server 100 will provide an IPv4 address to the client device 1008 via dynamic host configuration protocol (DHCP). Once the networking has been set up, if the personal handheld web server owner 512 has sent out a sharing invitation to the client device 1008, the recipient connects to the personal handheld web server 100 directly. The personal handheld web server 100 will then serve up the asset/content to the client 1008 via a standard HTTP GET request.

In the narrowcast Personal handheld web server 100 content sharing to an IPv6 device over LAN scenario, the personal handheld web server 100 will still be operating with a single-mode antenna (i.e. it will not itself be connected to another wireless access point/router to get to WAN/Internet). In this scenario, client devices 1006, 1008 and 1010 can still connect 1018, 1020 and 1022 to the personal handheld web server 100 directly. If the client device 1006 or 1010 is IPv6 capable, the personal handheld web server 100 will provide an IPv6 address to the client device 1006 or 1010 via DHCP. Once the networking has been set up, if the personal handheld web server owner 512 has sent out a sharing invitation to this client device 1006 or 1010, the recipient connects to the personal handheld web server 100 directly. The personal handheld web server 100 will then serve up the asset/content to the client 1006 or 1010 via a standard HTTP GET request.

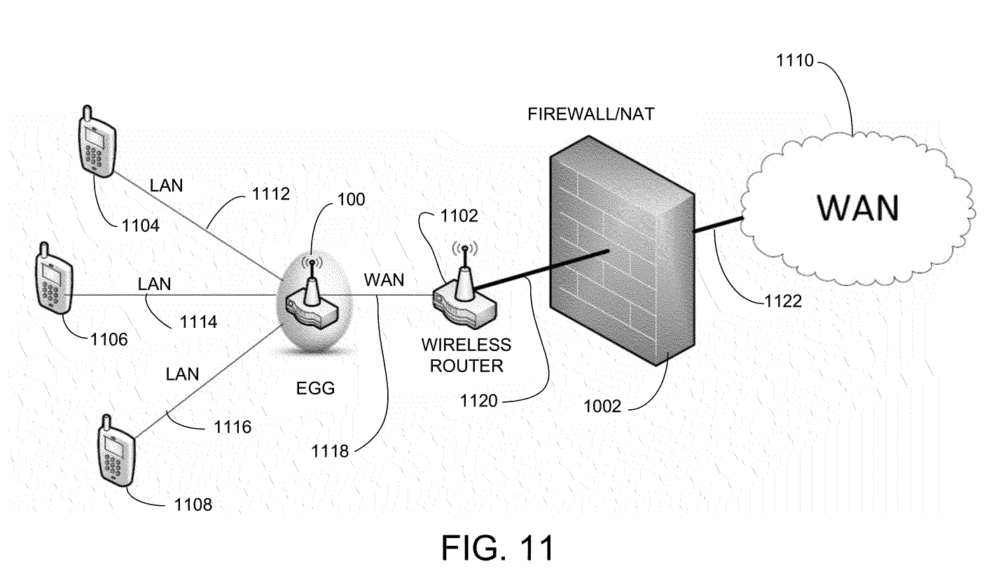

FIG. 11 is a diagrammatic view illustrating an exemplary embodiment of the personal handheld web server 100 of FIG. 1 communicating through a firewall 1002 to a wide area network 1110, according to a preferred embodiment of the present invention. The personal handheld web server 100 has a single Wi-Fi radio operating at 2.4 GHz. However, Personal handheld web server 100 can be set up in a split configuration mode where it can operate in both LAN mode (i.e. operate as a Wi-Fi access point to local client devices 1104, 1106, and 1108 on the LAN 1112, 1114 and 1116, respectively) and at the same time, WAN mode (i.e. act as a client and connect to another wireless router 1102 that has access to the WAN 1110). In LAN mode, the personal handheld web server 100 can serve any content such as photos and stream videos to devices 1104, 1106, and 1108 that are attached 1112, 1114 and 1116 to the personal handheld web server 100. The personal handheld web server 100 can also act as a conduit for external connectivity to the Internet by creating a pipe between its LAN and WAN connections.

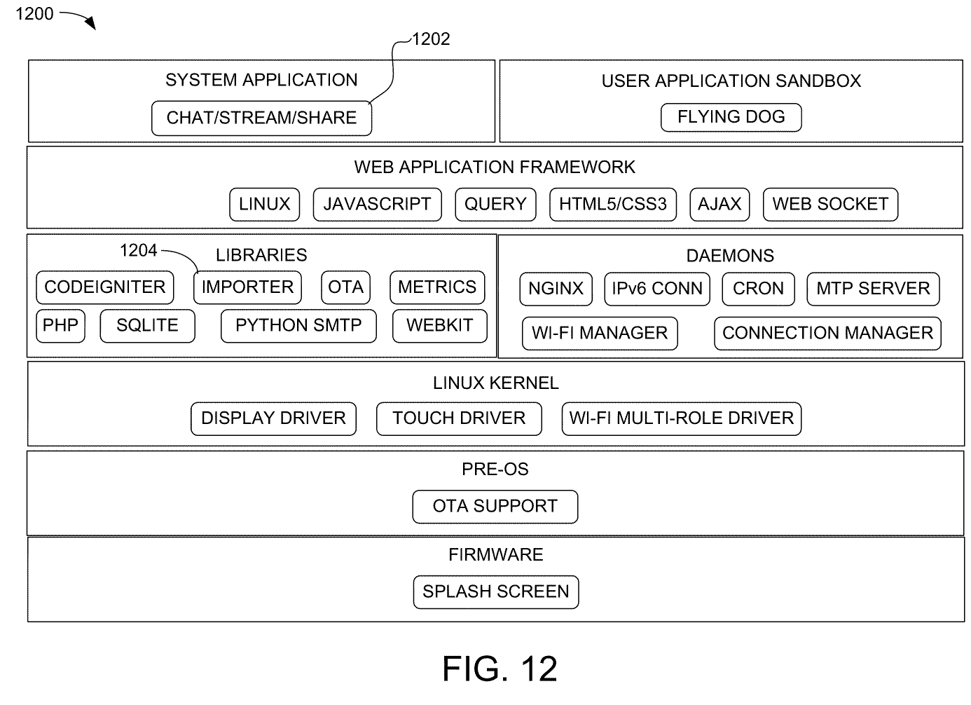

FIG. 12 is a diagrammatic view illustrating an exemplary embodiment of a software architecture 1200 of the personal handheld web server 100 of FIG. 1, according to a preferred embodiment of the present invention. Of particular interest are the system application 1202 and the importer library 1204. System application 1202 is responsible for functions 514, 516, 518, 520, 522, 530, 542, 538, and 546 related to chatting, acquiring, searching, displaying and streaming data. Importer library 1204 supports execution of functions 514, 516, 518, 520, 522, 530, 542, 538, and 546 with libraries for searching for, finding, duplicating, and removing files.

I claim:

1. A personal handheld web server comprising:
a. a housing small enough to be held in one hand and supporting;
i. a web server system;
ii. a communication system; and
iii. a touch screen display system; and
b. a fixed server on the Internet configured and dedicated to serve at least one said personal handheld web server.

2. The personal handheld web server of claim 1, comprising a first software application operable to enable a Wi-Fi or cellular enabled electronic device to communicate privately with at least one said personal handheld web server.

3. The personal handheld web server of claim 2, wherein said communications system comprises:
a. Wi-Fi a/b/g/n/ac/ad operable to provide Internet connectivity to said personal handheld web server;
b. WLAN radio operable to provide Internet connectivity to said personal handheld web server;
c. a local access point operable to provide local connectivity to said personal handheld web server by Wi-Fi enabled devices;
d. at least one micro USB port operable to provide battery charging and data transfer;
e. at least one USB port operable to provide data transfer;
f. internet protocol version 4 software;
g. internet protocol version 6 software;
h. software adapted to wrap an internet protocol version 6 message in an internet protocol version 4 wrapper;
i. a content importation software adapted to automatically import files from a device coupled to one of said micro USB port and said USB port;
j. an automatic configuration software adapted to automatically create access through a personal router using encrypted internet protocol version 6 tunneling;
k. an automatic email notification software to deliver notifications; and
l. an automatic push notification software to deliver notification from said personal handheld web server to different mobile devices using iOS, Android, Windows and Blackberry operating systems.

4. The personal handheld web server of claim 3, comprising a second software application on a USB-connectable device that is capable of taking at least one of an electronic photograph file, an electronic video recording file, an electronic music file, and any data file, said second software application adapted to cause said at least one of said files to be transferred to said personal handheld web server without said file ever residing in storage of said USB-connectable device.

5. The personal handheld web server of claim 3, comprising a third software application on a Wi-Fi or cellular enabled device having a display screen, said third software application adapted to stream display content from said personal handheld web server to said Wi-Fi or cellular enabled device having a display screen, wherein said content is never stored on said Wi-Fi or cellular enabled device having a display screen.

6. The personal handheld web server of claim 3, comprising a fourth software application on a Wi-Fi enabled or cellular enabled device having a display screen, said fourth software application adapted to provide chat services wherein said personal handheld web server is configured as a host, wherein the contents of said chat do not persist on said Wi-Fi enabled device having a display screen, but are pulled real-time from said host and are not stored in any place when said fourth application terminates.

7. The personal handheld web server of claim 1, wherein said web server system is adapted to provide:
a. a unique URL;
b. a website host;
c. access to said personal handheld web server from one of:
i. an Internet browser;
ii. an Android phone; and
iii. an iPhone.

8. The personal handheld web server of claim 1, wherein said touch screen display system comprises:
a. a touch screen;
b. user interface software adapted to provide a user interface adapted to said personal handheld web server via said touch screen;
c. a microcontroller, running said user interface software, in communication with said touch screen.

9. A personal handheld web server comprising:
a. a housing small enough to be held in one hand and supporting;
i. a web server system;
ii. a communication system; and
iii. a touch screen display system;
b. a fixed server on the Internet configured and dedicated to serve at least one said personal handheld web server; and
c. a first software application operable to enable a Wi-Fi enabled electronic device to communicate privately with at least one said personal handheld web server.

10. The personal handheld web server of claim 9, wherein said communications system comprises:
a. Wi-Fi a/b/g/n/ac/ad operable to provide Internet connectivity to said personal handheld web server;
b. WLAN or cellular radio operable to provide Internet connectivity to said personal handheld web server;
c. a local access point operable to provide local connectivity to said personal handheld web server by Wi-Fi enabled devices;
d. at least one micro USB port operable to provide battery charging and data transfer;
e. at least one USB port operable to provide data transfer;
f. internet protocol version 4 software;
g. internet protocol version 6 software;
h. software adapted to wrap an internet protocol version 6 message in an internet protocol version 4 wrapper;
i. a content importation software adapted to automatically import files from a device coupled to one of said micro USB port and said USB port;
j. an automatic configuration software adapted to automatically create access through a personal router using encrypted internet protocol version 6 tunneling;
k. an automatic email notification software to deliver notifications from said personal handheld web server; and
l. an automatic push notification software to deliver notification from said personal handheld web server to different mobile devices using iOS, Android, Windows and Blackberry operating systems

11. The personal handheld web server of claim 10, comprising:
a. a second software application on a USB-connectable device that is capable of taking at least one of an electronic photograph file, an electronic video recording file, an electronic music file, and any data file, said second software application adapted to cause said at least one of said files to be transferred to said personal handheld web server without said file ever residing in storage of said USB-connectable device;
b. a third software application on a Wi-Fi or cellular enabled device having a display screen, said third software application adapted to stream display content from said personal handheld web server to said Wi-Fi or cellular enabled device having a display screen, wherein said content is never stored on said Wi-Fi or cellular enabled device having a display screen; and
c. comprising a fourth software application on a Wi-Fi enabled or cellular enabled device having a display screen, said fourth software application adapted to provide chat services wherein said personal handheld web server is configured as a host, wherein the contents of said chat do not persist on said Wi-Fi enabled or cellular device having a display screen, but are pulled real-time from said host and are not stored in any place when said fourth application terminates.

12. The personal handheld web server of claim 9, wherein said web server system is adapted to provide:
a. a unique URL;
b. a website host;
c. access to said personal handheld web server from one of:
i. an Internet browser;
ii. an Android phone; and
iii. an iPhone.

13. The personal handheld web server of claim 9, wherein said touch screen display system comprises:
a. a touch screen;
b. user interface software adapted to provide a user interface adapted to said personal handheld web server via said touch screen;
c. a microcontroller, running said user interface software, in communication with said touch screen.

14. A personal handheld web server comprising:
a. a housing small enough to be held in one hand;
b. a web server system comprising:
i. a central processing unit;
ii. a double data rate type three synchronous dynamic random-access memory in communication with said central processing unit;
iii. a secure digital input output device, operable to receive a secure digital card, including a wireless local network receiver, a Bluetooth receiver, and a frequency modulated radio receiver in communication with said central processing unit;
iv. a power management integrated circuit operable to provide multi-channel power management in communication with said central processing unit;
v. a micro USB socket coupled to said power management integrated circuit and to a USB switch, wherein said USB switch is in communication with said central processing unit and a USB transceiver integrated circuit that, in turn, is in communication with said central processing unit;
vi. a USB socket in communication with said central processing unit;
vii. a high-definition multimedia interface port in communication with said central processing unit;
viii. a video converter in communication with said central processing unit and operable to convert mobile industry processor interface standard signals originating in said central processing unit into RGB video signals;
ix. an RGB panel, comprising a touch screen, in communication with said video converter, operable to display images represented by said RGB video signals;
x. a flash-based CMOS microcontroller in communication with said RGB panel;
xi. a flash memory in communication with said central processing unit;
xii. a secure digital card socket in communication with said central processing unit;
xiii. an embedded memory management controller in communication with said central processing unit;
c. a fixed web server coupled to an Internet and dedicated to serving at least one said personal handheld web server; and
d. a first software application operable to enable a Wi-Fi enabled electronic device to communicate privately with at least one said personal handheld web server.

15. The personal handheld web server of claim 14, wherein said communications system comprises:
a. Wi-Fi a/b/g/n/ac/ad operable to provide Internet connectivity to said personal handheld web server;
b. WLAN or cellular radio operable to provide Internet connectivity to said personal handheld web server;
c. a local access point operable to provide local connectivity to said personal handheld web server by Wi-Fi enabled devices;
d. at least one micro USB port operable to provide battery charging and data transfer;
e. at least one USB port operable to provide data transfer;
f. internet protocol version 4 software;
g. internet protocol version 6 software;
h. software adapted to wrap an internet protocol version 6 message in an internet protocol version 4 wrapper;
i. a content importation software adapted to automatically import files from a device coupled to one of said micro USB port and said USB port;
j. an automatic configuration software adapted to automatically create access through a personal router using encrypted internet protocol version 6 tunneling;
k. an automatic email notification software to deliver notifications; and
l. an automatic push notification software to deliver notification from said personal handheld web server to different mobile devices using iOS, Android, Windows and Blackberry operating systems.

16. The personal handheld web server of claim 15, comprising a second software application on a USB-connectable device that is capable of taking at least one of an electronic photograph file, an electronic video recording file, an electronic music file, and any data file, said second software application adapted to cause said at least one of said files to be transferred to said personal handheld web server without said file ever residing in storage of said USB-connectable device.

17. The personal handheld web server of claim 15, comprising a third software application on a Wi-Fi or cellular enabled device having a display screen, said third software application adapted to stream display content from said personal handheld web server to said Wi-Fi or cellular enabled device having a display screen, wherein said content is never stored on said Wi-Fi or cellular enabled device having a display screen.

18. The personal handheld web server of claim 15, comprising a fourth software application on a Wi-Fi enabled or cellular enabled device having a display screen, said fourth software application adapted to provide chat services wherein said personal handheld web server is configured as a host, wherein the contents of said chat do not persist on said Wi-Fi enabled device having a display screen, but are pulled real-time from said host and are not stored in any place when said fourth application terminates.

19. The personal handheld web server of claim 1, wherein said web server system is adapted to provide:
a. a unique URL;
b. a website host;
c. access to said personal handheld web server from one of:
i. an Internet browser;
ii. an Android phone; and
iii. an iPhone.

20. The personal handheld web server of claim 14, wherein said touch screen display system comprises:
a. said touch screen;
b. user interface software adapted to provide a user interface adapted to said personal handheld web server via said touch screen;
c. said microcontroller, running said user interface software, in communication with said touch screen.
